(19) United States
(12) Patent Application Publication
(10) Pub. No.: US 2022/0156638 A1
(43) Pub. Date: May 19, 2022

(54) ENHANCING DATA GENERATION WITH RETINFORCEMENT LEARNING

(71) Applicant: International Business Machines Corporation, Armonk, NY (US)

(72) Inventors: Guandong Zhu, Raleigh, NC (US); Yi-Hui Ma, Mechanicsburg, PA (US); Shuyan Lu, Cary, NC (US); Junhui Wang, Cary, NC (US); Chuan Ran, Morrisville, NC (US)

(21) Appl. No.: 17/098,868

(22) Filed: Nov. 16, 2020

(51) Int. Cl. G06N 20/00

(52) U.S. Cl. CPC G06N 20/00

(57) ABSTRACT

Aspects of the present invention disclose a method, computer program product, and system for improving data simulation using reinforcement learning. The method includes one or more processors generating a first simulated data set based on a first parameter set. The method further includes generating a second parameter set, by modifying one or more parameters of the first parameter set, and then generating a second simulated data set based on the second parameter set. The method further includes determining data discrepancies between the first simulated data set and a target data set and determining data discrepancies between the second simulated data set and the target data set. The method further includes selecting between the first and second simulated data sets, a first data set that corresponds to fewer data discrepancies relative to the target, then comparing data discrepancies of the selected first data set to a data discrepancy threshold.

### BACKGROUND OF THE INVENTION

The present invention relates generally to the field of data analysis, and more particularly to data generation utilizing reinforcement learning.

Reinforcement learning (RL) is an area of machine learning concerned with how software agents take actions in an environment in order to maximize the notion of cumulative reward. Reinforcement learning is one of three basic machine learning paradigms, alongside supervised learning and unsupervised learning. Reinforcement learning differs from supervised learning in not needing labelled input/output pairs be presented, and in not needing sub-optimal actions to be explicitly corrected. Instead the focus is on finding a balance between exploration (of uncharted territory) and exploitation (of current knowledge).

Due to its generality, reinforcement learning is studied in many disciplines, such as game theory, control theory, operations research, information theory, simulation-based optimization, multi-agent systems, swarm intelligence, and statistics. In the operations research and control literature, reinforcement learning is called approximate dynamic programming, or neuro-dynamic programming. The problems of interest in reinforcement learning have also been studied in the theory of optimal control, which is concerned mostly with the existence and characterization of optimal solutions, and algorithms for their exact computation, and less with learning or approximation, particularly in the absence of a mathematical model of the environment. In economics and game theory, reinforcement learning may be used to explain how equilibrium may arise under bounded rationality. Basic reinforcement can be modeled as a Markov decision process (MDP).

Game theory is the study of mathematical models of strategic interaction among rational decision-makers. Game theory has applications in all fields of social science, as well as in logic, systems science and computer science. Originally, game theory addressed zero-sum games, in which each participant's gains or losses are exactly balanced by those of the other participants. In the 21st century, game theory applies to a wide range of behavioral relations and is now an umbrella term for the science of logical decision making in humans, animals, and computers.

### SUMMARY

Aspects of the present invention disclose a method, computer program product, and system for improving data simulation using reinforcement learning. The method includes one or more processors generating a first simulated data set based on a first parameter set. The method further includes one or more processors generating a second parameter set, by modifying one or more parameters of the first parameter set. The method further includes one or more processors generating a second simulated data set based on the second parameter set. The method further includes one or more processors determining data discrepancies between the first simulated data set and a target data set. The method further includes one or more processors determining data discrepancies between the second simulated data set and the target data set. The method further includes one or more processors selecting between the first simulated data set and the second simulated data set, a first data set that corresponds to less data discrepancy relative to the target data set. The method further includes one or more processors comparing data discrepancies of the selected first data set to a data discrepancy threshold.

In another embodiment, the method further includes, in response to determining that the selected first data set does not meet the data discrepancy threshold, one or more processors, a third parameter set, by modifying one or more parameters of the parameter set that corresponds to the first selected data set. In a further embodiment, the method further includes one or more processors generating a third simulated data set based on the third parameter set. The method further includes one or more processors determining data discrepancies between the third simulated data set and the target data set. The method further includes one or more processors selecting between the selected first data set and the third simulated data set, a second data set that corresponds to less data discrepancy relative to the target data set. The method further includes one or more processors comparing data discrepancies of the selected second data set to a data discrepancy threshold.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for performing reinforcement learning, in accordance with embodiments of the present invention.

FIG. 3 depicts a block diagram of components of a computing system representative of the server of FIG. 1, in accordance with an embodiment of the present invention.

### DETAILED DESCRIPTION

Embodiments of the present invention allow for improving data simulation using reinforcement learning. In various aspects, embodiments of the present invention can operate to generate a simulated data set based on a first parameter set. Then, embodiments of the present invention can generate an updated parameter set, and another simulated data set based on the updated parameter set. Embodiments of the present invention can then operate to determine data discrepancy scores for both generated data sets, respectively relative to a set of target data (e.g., data from a customer). In response to determining that the smaller respective data discrepancy score is not below a defined threshold condition, embodiments of the present invention generate another updated parameter set and then generate another corresponding simulated data set, to repeat the reinforcement learning process until the defined data discrepancy threshold is met. In response to determining that the defined threshold is met, embodiments of the present invention stores the parameter set that meets the data discrepancy score threshold.

Accordingly, some embodiments of the present invention can operate to automatically tune and improve a data generator and the data simulation process to reduce discrepancies and/or distortions between simulated data and real customer data (e.g., target data sets). In various aspects, embodiments of the present invention provide an adaptive framework, which incorporates reinforcement learning, that can apply to various business and technology areas (e.g., financial procedures, insurance calculations and analysis, and other areas of data analytics).

Embodiments of the present invention recognize that when generating data samples with high similarity to real data, many parameters will need to be tuned in the process. For example, when data scientists want to generate a sample case using Poisson distribution, the data scientists choose the parameter A. Embodiments of the present invention recognize that all of the parameters and the different combinations can have a profound effect on the generated data. In addition, embodiments of the present invention recognize that manually tuning all the parameters would be time consuming and inaccurate. Further, different combinations of parameters can also shift the joint distribution of the sample data, which makes a manual work of parameters tuning more unrealistic. Accordingly, embodiments of the present invention operate to provide a reinforcement learning based approach to improve the quality of the generated sample data.

Implementation of embodiments of the invention may take a variety of forms, and exemplary implementation details are discussed subsequently with reference to the Figures.

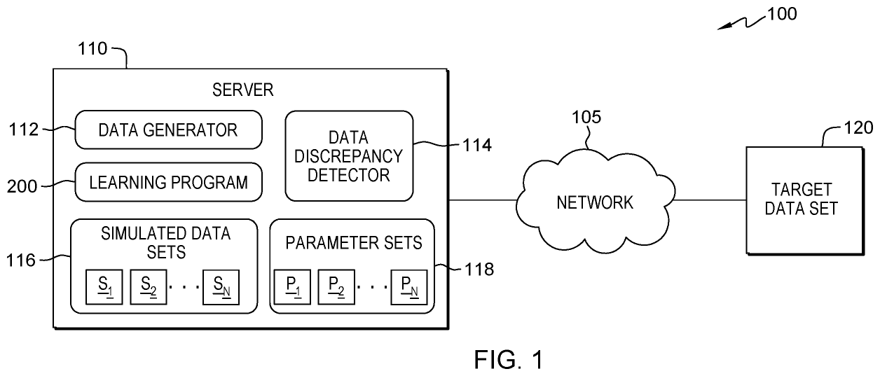

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes server 110 and target data set 120, all interconnected over network 105. In an example embodiment, server 110 is representative of a computing device (e.g., one or more management servers) that provides data analysis services (e.g., services for one or more organizations and users). For example, server 110 hosts/provides data generation services, and also operates to improve data generators (e.g., data generator 11) utilizing reinforcement learning, in accordance with various embodiments of the present invention. In other embodiments, data processing environment 100 can include additional instances of computing devices (not shown) that can interface with server 110, in accordance with various embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between server 110, target data set 120, and other network-accessible devices/content (not shown), in accordance with embodiments of the present invention. In various embodiments, network 105 facilitates communication among a plurality of networked computing devices (e.g., server 110, and other devices not shown), corresponding users, data resources (e.g., target data set 120, and other network-accessible data), and corresponding management services (e.g., server 110).

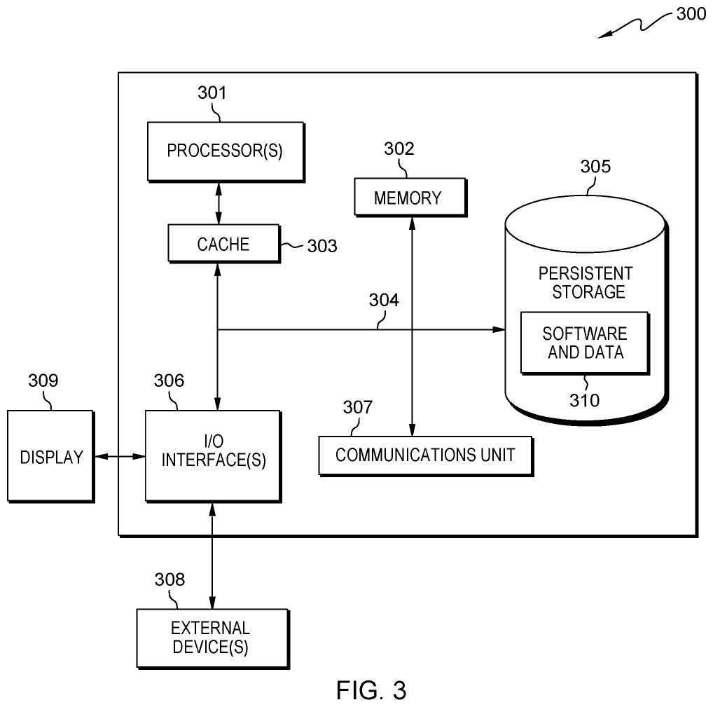

In example embodiments, server 110 can be a desktop computer, a computer server, or any other computer systems, known in the art. In certain embodiments, server 110 represents computer systems utilizing clustered computers and components (e.g., database server computers, application server computers, etc.) that act as a single pool of seamless resources when accessed by elements of data processing environment 100 (e.g., computing devices and other devices not shown). In general, server 110 is representative of any electronic device or combination of electronic devices capable of executing computer readable program instructions. Server 110 may include components as depicted and described in further detail with respect to FIG. 3, in accordance with embodiments of the present invention.

Server 110 includes data generator 112, data discrepancy detector 114, simulated data sets 116, parameter sets 118, and learning program 200. In various embodiments, server 110 operates as a computing system that provides data analysis services and data generation services. In additional embodiments, server 110 also operates to perform reinforcement learning on data models and data generators, to improve accuracy and functionality, in accordance with various embodiments of the present invention. For example, server 110 hosts data generator 112 and can utilize learning program 200 to improve the functioning of data generator 112 (e.g., based on analyzing and optimizing parameter sets). In additional embodiments, server 110 can access external data sources, such as target data set 120, to assist in the reinforcement learning process (i.e., executing learning program 200), in accordance with various embodiments of the present invention.

In various embodiments of the present invention, users associated with data that server 110 can access and analyze can register with server 110 (e.g., via a corresponding application). For example, the user completes a registration process, provides information, and authorizes the collection and analysis (i.e., opts-in) of relevant data provided, by server 110 (e.g., user profile information, user contact information, authentication information, user preferences, or types of information, for server 110 utilize with learning program 200 and for operations of data generator 112). In various embodiments, a user can opt-in or opt-out of certain categories of data collection. For example, the user can opt-in to provide all requested information, a subset of requested information, or no information. In additional embodiments, the users can define which information that server 110 can utilize in (e.g., as parameters, etc.) generating and analyzing data, in accordance with embodiments of the present invention.

In various embodiments, data generator 112 is representative of a data generation and/or data simulation application, in accordance with embodiments of the present invention. In an example embodiment, an insurance data generator can operate to generate information that includes policy holders, insurance policies, vehicles, incidents, medical billing information, insurance claims, etc. In another example embodiment, a bank transaction data generator can operate to generate information that includes account information, account counter data, a plurality (e.g., a series) of transactions, etc.

Embodiments of the present invention recognize that, when simulating data (e.g., bank transaction data, insurance claim data, etc.), data scientists often utilize pre-defined parameters to control the data generation/simulation to generate data according to some distribution. For example, in an insurance claim, the amount of vehicle loss corresponds to a normal distribution on vehicle brand and accident reason, with a mean value and variance. Thus, the data generation can utilize mean value and variance as predefined the pre-defined parameters of the processing.

In example embodiments, data generator 112 can include one or more models that generate data. In one example scenario, data generator 112 can include (or be associated with) a long short-term memory (LSTM) network (e.g., or other type/form of artificial recurrent neural network (RNN) architectures) that receives an initial set of information (e.g., a data record) as input, and outputs a more complete version of information. For example, a user (e.g., a user associated with server 110) can feed a data record that includes temporal and spatial information of an insurance claim to data generator 112. In this example, data generator 112 can utilize an LSTM network to analyze the received data record and output additional data for the insurance claim (e.g., a complete insurance claim record based on the input data record). In another example scenario, data generator 112 can utilize (and/or include) a model that performs an up sampling with noises that are subject to a statistical distribution. In further embodiments, data generator 112 can utilize (e.g., receive as input and provide as output) both numeric data and/or categorical data, in accordance with various embodiments of the present invention.

In additional embodiments, data generator 112 can be located remote to server 110 (e.g., on a separate server computer, not shown) and accessible to server 110 (via network 105). Accordingly, server 110 can utilize a remote instance of data generator 112 in combination with processing steps of learning program 200, in accordance with various embodiments of the present invention.

In another embodiment, data discrepancy detector 114 is representative of an application or software module on server 110 that can operate to identify discrepancies between sets of data. For example, data discrepancy detector 114 compares data sets generated by data generator 112 to customer data (e.g., target data set 120) to identify discrepancies between the data sets. In addition, data discrepancy detector 114 determines a score based on the result of the comparison. In further embodiments, data discrepancy detector 114 can be located remote to server 110 (e.g., on a separate server computer, not shown) and accessible to server 110 (via network 105). Accordingly, server 110 can utilize a remote instance of data discrepancy detector 114 in combination with processing steps of learning program 200, in accordance with various embodiments of the present invention.

In example embodiments, data discrepancy detector 114 can operate to apply classification algorithms to a mixture of generated/simulated data (e.g., data sets of simulated data sets 116) and a defined set of data, such as real customer data (e.g., target data set 120). In an example scenario, if data discrepancy detector 114 is able to utilize a classification algorithm to classify the mixture of data correctly into the two categories (i.e., into the respective generated/simulated data and the defined set of data), then data discrepancy detector 114 determines a high degree of discrepancy. Accordingly, data discrepancy detector 114 can assign a high data discrepancy score. In another example scenario, data discrepancy detector 114 can utilize clustering approaches to determine a degree of data discrepancy. For example, if the generated/simulated data (e.g., data sets of simulated data sets 116) and a defined set of data (e.g., target data set 120) are nearly half-and-half in most clusters, then data discrepancy detector 114 can determine a low data discrepancy score.

In an additional aspect, data discrepancy detector 114 can determine a score based on an f-score (or f-measure) of the analysis of the mixture of data. In another aspect, data discrepancy detector 114 can utilize area under curve (AUC) to determine a corresponding data discrepancy score, or other metrics that can represent a degree of discrepancy, in accordance with various embodiments of the present invention.

In various embodiments, data discrepancy detector 114 can operate to determine data discrepancies utilizing a subset of dimensions of the analyzed data sets. For example, in many business scenarios, data sets can include a large number of dimensions. Data discrepancy detector 114 can utilize a subset of the dimensions even while data discrepancy detector 114 receives data with a complete set of dimensions (i.e., data generator 112 and learning program 200 operate to simulate and provide a complete set of data with all dimensions). Accordingly, data discrepancy detector 114 can apply a fewer amount of restrictions and focus on a particular set of features/dimensions for a lower discrepancy.

Server 110 includes simulated data sets 116 and parameter sets 118. In an example embodiment, server 110 can store simulated data sets 116 and parameter sets 118 in a storage device, which can be implemented with any type of storage device, for example, persistent storage 305, which is capable of storing data that may be accessed and utilized by server 110, such as a database server, a hard disk drive, or a flash memory. In other embodiments, server 110 can store simulated data sets 116 and parameter sets 118 across multiple storage devices and collections of data within server 110.

In various embodiments, simulated data sets 116 is a collection of data that data generator 112 can generate, in accordance with various embodiments of the present invention. In example embodiments, data generator 112 utilizes parameters, of parameter sets 118, to generate simulated data sets that are stored in simulated data sets 116. Simulated data sets 116 includes data set S₁, data set S₂, through data set Sₙ, which are each respectively representative of a generated/simulated data set based on a corresponding parameter set. In an example scenario, an insurance data generator can operate to generate a simulated data set that includes policy holders, insurance policies, vehicles, incidents, medical billing information, insurance claims, etc. In another example scenario, a bank transaction data generator can generate a simulated data set that includes account information, credit scores, account counter data, a plurality (e.g., a series) of transactions, etc. In additional aspects, generated simulated data sets can include any monetary, temporal, and/or spatial data, based on the area of implementation of the respective data generator.

In further embodiments, parameter sets 118 are collections of parameters that data generator 112 utilizes to generate simulated data sets, in accordance with various embodiments of the present invention. In addition, server 110 (e.g., utilizing data generator 112 and/or learning program 200) generates the respective parameter sets of parameter sets 118, through the reinforcement learning process of executing learning program 200. Parameter sets 118 includes parameter set P₁, parameter set P₂, through parameter set Pₙ, which are each respectively representative of sets of parameters of different values, in accordance with embodiments of the present invention. In example embodiments, data generator 112 utilizes parameter set P₁ to generate data set S₁, parameter set P₂ to generate data set S₂, and through to utilize parameter set Pₙ to generate data set Sₙ.

In various embodiments, the parameters of parameter sets 118 include, but is not limited to, parameters of a probability distribution that the corresponding data generator (e.g., data generator 112) is built upon. In an example embodiment, data generator 112 can utilize a Poisson distribution for a data difference between bank transactions and utilize a normal distribution for the amount of loss in a traffic accident. Accordingly, the parameters of the Poisson distribution and the normal distribution are part of the parameter set. In another example embodiment, data generator 112 can utilize additional parameters to control the relationship between weather and the total amount of loss in an accident, such as a linear regression instead of probability distributions.

In example embodiments, learning program 200 operates to improve data simulation using reinforcement learning, in accordance with embodiments of the present invention. In various embodiments, learning program 200 generates a simulated data set based on an initial parameter set. For example, learning program 200 generates (utilizing data generator 112) data set S₁ based on parameter set P₁. Then, learning program 200 can generate an updated parameter set, and another simulated data set based on the updated parameter set. For example, learning program 200 generates (utilizing data generator 112) data set S₂ based on parameter set P₂.

Learning program 200 can then operate to determine data discrepancy scores for both generated data sets, respectively relative to a set of target data (e.g., data from a customer). For example, learning program 200 utilizes data discrepancy detector 114 to generate a data discrepancy score between data set S₁ and target data set 120 (e.g., customer data) and to generate a data discrepancy score between data set S₂ and target data set 120. In response to determining that the smaller respective data discrepancy score is not below a defined threshold condition, learning program 200 generates another updated parameter set and then generate another corresponding simulated data set, to repeat the reinforcement learning process until the defined data discrepancy threshold is met. For example, learning program 200 can execute until a data discrepancy score for a generated data set meets a threshold condition (i.e., until identifying data set Sₙ based on parameter set Pₙ).

In various embodiments, learning program 200 can execute to perform reinforcement learning for data generator 112. For example, learning program 200 utilizes the generated data sets as the “state” and the data discrepancies relative to the customer data (e.g., target data set 130) is the “reward.” In a typical reinforcement learning scenario, an agent takes actions in an environment, which is interpreted into a reward and a representation of the state, which are fed back into the agent.

In addition, embodiments of the present invention recognize that when generating data samples with high similarity to real data, many parameters will need to be tuned in the process. For example, when data scientists want to generate a sample case using Poisson distribution, the data scientists choose the parameter A. Embodiments of the present invention recognize that all of the parameters and the different combinations can have a profound effect on the generated data. In addition, embodiments of the present invention recognize that manually tuning all the parameters would be time consuming and inaccurate. Further, different combinations of parameters can also shift the joint distribution of the sample data, which makes a manual work of parameters tuning more unrealistic. Accordingly, embodiments of the present invention operate to provide (through learning program 200) a reinforcement learning based approach to improve the quality of the generated sample data.

Target data set 120 is representative of a set of data that server 110 (and learning program 200) utilizes as a reference data set, in accordance with embodiments of the present invention. For example, target data set 120 can be real customer data, for use in the reinforcement learning process. In an alternate embodiment, target data set 120 can be located (e.g., hosted, stored, persisted, etc.) on server 110. In other embodiments, target data set 120 is network-accessible (via network 105) to server 110. In another aspect, customer data may be a limited size. In such examples, target data set 120 can be representative of a mixture of data sets from multiple customers with a common data type, thus making the combination correspond to a more generic data set, for utilization in accordance with various embodiments of the present invention.

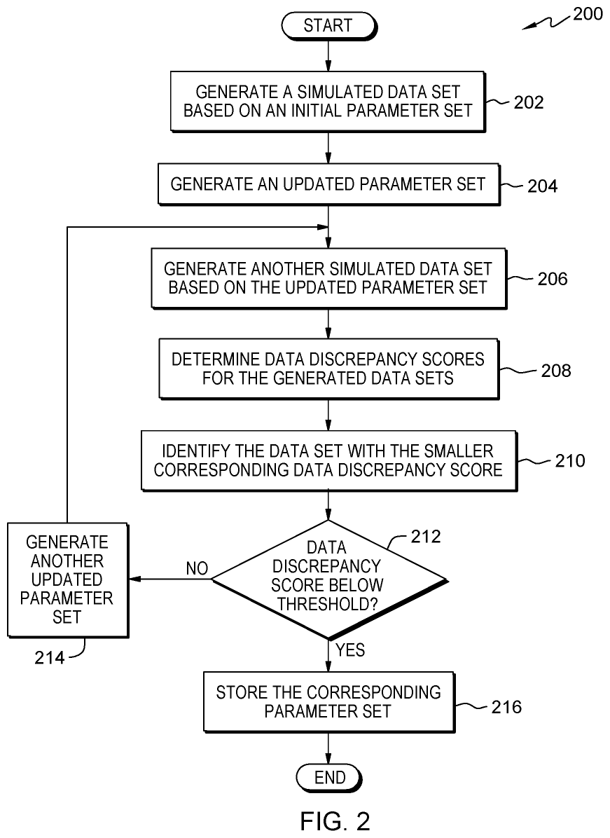

FIG. 2 is a flowchart depicting operational steps of learning program 200, a program for performing reinforcement learning, in accordance with embodiments of the present invention. In one embodiment, learning program 200 initiates (and iterates) to analyze (and/or optimize) a data generator, such as data generator 112. The data generator can relate to a variety of applications, such as finance, insurance, banking, etc. In an example embodiment, learning program 200 can initiate in response to receiving an identification of data generator 112 to improver utilizing reinforcement learning techniques, in accordance with various embodiments of the present invention.

In step 202, learning program 200 generates a simulated data set based on an initial parameter set. In one embodiment, learning program 200 utilizes data generator 112 to generate a simulation of a data set based on a set of parameters. In another embodiment, learning program 200 instructs data generator 112 to generate the simulation of the data set based on the set of parameters. In an example embodiment, data generator 112 generates data set S₁ based on parameter set P₁, which are respectively stored in simulated data sets 116 and parameter sets 118. In an example scenario, data generator 112 can operate to generate data for an insurance application. For example, data generator can generate a data set (e.g., data set S₁) to include data simulations of a policy holder, a policy, a vehicle, an incident, medical bills, claims, etc. In various aspects, the resulting date from data generator 112 can vary in different scenarios, while still maintaining a common format to the format of target data set 120.

In an example scenario, a data analyst can business logic into graphical representations utilizing data generator 112, where the nodes are objects described by the data and the edges are probability distributions that the connected nodes are subject to. In this example scenario, data generator 112 can start at a starting point and then use the distributions to infer other values with sampling techniques. In this example scenario, embodiments of the present invention can operate to tune and correct the assumptions of the distributions.

In another embodiment, learning program 200 can operate determine whether a data discrepancy score that corresponds to the simulated data set based on the initial parameter set meets a data discrepancy threshold condition. In example embodiments, learning program 200 can proceed from step 202 to step 208, to determine a data discrepancy score (relative to target data set 120) for the simulated data set based on the initial parameter set. Learning program 200 utilizes data discrepancy detector 114, as described above with regard to FIG. 1, and below with regard to step 208, to determine the corresponding data discrepancy score, in accordance with embodiments of the present invention. Further, learning program 200 can then determine whether the data discrepancy score that corresponds to the simulated data set based on the initial parameter set meets a data discrepancy threshold condition, as described in further detail later with regard to decision step 212. Accordingly, in this embodiment, learning program can operate to determine whether data generator 112 can utilize the initial parameter set to generate data that is sufficiently close to the desired target data (i.e., target data set 120).

In step 204, learning program 200 generates an updated parameter set. In one embodiment, learning program 200 generates a second set of parameters that data generator 112 can utilize. In another embodiment, learning program 200 can generate the second set of parameters by making modifications to the initial set of parameters (utilized in step 202). In example embodiments, learning program 200 modifies a subset of the parameters in the initial parameter set to generate the second parameter set. For example, learning program 200 randomly determines a subset of parameters of parameter set P₁. Then, learning program 200 modifies the randomly determined subset of parameters to generate the updated parameter set, i.e., parameter set P₂.

In various embodiments, learning program 200 can make a minor disturbance (e.g., a small change) to the determined subset of parameters (e.g., modify the parameters utilizing a small delta value, dₚ) to generate the updated parameter set. In other example embodiments, learning program 200 can utilize a defined delta value (dₚ) to consistently modify parameter sets through the iterations of the reinforcement learning process, in accordance with various embodiments of the present invention.

In step 206, learning program 200 generates another simulated data set based on the updated parameter set. In one embodiment, learning program 200 utilizes (or instructs) data generator 112 to generate another simulation of a data set based on the updated set of parameters (generated in step 204). In an example embodiment, data generator 112 generates data set S₂ based on parameter set P₂, which are respectively stored in simulated data sets 116 and parameter sets 118. In various embodiments, learning program 200 (and data generator 112) can operate to generate another simulated data set according to the process previously described above with regard to step 202.

In step 208, learning program 200 determines data discrepancy scores for the generated data sets. In one embodiment, learning program 200 utilizes data discrepancy detector 114 to determine respective data discrepancy scores for data set S₁ (generated in step 202) and data set S₂ (generated in step 206) relative to a defined set of data (e.g., target data set 120). In example embodiments, learning program 200 runs data discrepancy detector 114 against the simulated data sets (from step 202 and 206) and target data set 120 (e.g., customer data). Accordingly, data discrepancy detector 114 can determine respective data discrepancy scores for each set of simulated data, i.e., data discrepancy score D₁ corresponds to data set S₁, data discrepancy score D₂ corresponds to data set S₂, etc. In various embodiments, a larger data discrepancy score corresponds to more discrepancies between information in the compared data sets.

Exemplary processes for identify and determine discrepancies between sets of data is previously described in further detail above with regard to data discrepancy detector 114 in FIG. 1. In example embodiments, learning program 200 can utilize an approach that measures the distance between two sets of data, or the opposite of the similarity of the two sets of data, in accordance with various embodiments of the present invention (e.g., probability distribution distance, etc.).

In step 210, learning program 200 identifies the data set with the smaller corresponding data discrepancy score. In one embodiment, learning program 200 identifies which data discrepancy score determined in step 208 is smaller, therefore indicating a smaller degree of discrepancy between the corresponding data set and target data set 120. In various embodiments, learning program 200 operates to identify the data set (e.g., between data set S₁ and data set S₂) that is closer to the target (i.e., target data set 120). Accordingly, learning program 200 can identify which parameter set is closer to optimal, based on relationship to the data set with the lower data discrepancy score (i.e., data generator 112 utilized the parameter set to generate the corresponding simulated data set). In an example scenario, learning program 200 determines that data discrepancy score D₁ (which corresponds to data set S₁) is smaller than data discrepancy score D₂ (which corresponds to data set S₂). Accordingly, learning program 200 identified data set Si to utilize in further processing of the reinforcement learning process.

In decision step 212, learning program 200 determines whether the identified data discrepancy score is below a threshold. In one embodiment, learning program 200 compares the data discrepancy score that corresponds to the data set identified in step 210 to a defined threshold value of data discrepancy. In another aspect, learning program 200 can utilize a threshold of no data discrepancy (i.e., learning program 200 iterates until a generated/simulated data set matches target data set 120).

In additional embodiments, learning program 200 utilizes decision step 212 as a feedback loop to determine whether to continue the reinforcement learning process for the data generator. In response to determining that the identified data discrepancy score is not below the established threshold (decision step 212, NO branch), learning program 200 generates another updated parameter set (step 214) and continues operation until learning program 200 determines a data discrepancy score that is below the established threshold. In response to response to determining that the identified data discrepancy score is below the established threshold (decision step 212, YES branch), learning program 200 stores the corresponding parameter set (step 216).

In step 214, learning program 200 generates another updated parameter set. In one embodiment, learning program 200 generates another set of parameters that data generator 112 can utilize. In various embodiments, generating an updated parameter set is previously described in further detail with regard to step 204. In an example scenario, learning program 200 (in step 210) identified data set S₁ to utilize in further processing of the reinforcement learning process. In this example scenario, learning program 200 modifies parameter set P₁ to generate another updated parameter set (i.e., parameter set P₃). For example, learning program 200 updates a subset of parameters in the parameter set by a defined step length (e.g., a tunable hyperparameter). In further aspects, learning program 200 can modify any amount of parameters (including all parameters) in the parameter set in order to generate an updated parameter set.

In further embodiments, after generating the updated parameter set in step 214 (e.g., parameter set P₃), learning program 200 returns to step 206, to generate another simulated data set. In example embodiments, learning program 200 generates data set S₃, based on parameter set P₃. Then, learning program 200 continues execution of steps 208 through 212, utilizing a comparison of data set S₁ and data set S₃, to continue iterating the reinforcement learning process in accordance with embodiments of the present invention.

In step 216, learning program 200 stores the corresponding parameter set. More specifically, in response to determining that the identified data discrepancy score is below the established threshold (decision step 212, YES branch), learning program 200 stores the parameter set that has the corresponding data discrepancy score (based on the data set comparison in steps 208 and 210) that is below the established threshold. Accordingly, by determining the parameter set that satisfies the data discrepancy threshold, learning program 200 successfully optimizes data generator 112 to generate simulated data that is sufficiently close to the desired target data (i.e., target data set 120). Further, learning program 200 stores the optimized parameter set so that data generator 112 (and corresponding individuals) can utilize the parameter set to generate accurate data.

In further embodiments, data discrepancy detector 114 can periodically analyze data generated by data generator 112, to determine whether data stays within the defined data discrepancy threshold. In response to determining a deviation, server 110 can reinitiate learning program 200 to perform reinforcement learning, in accordance with embodiments of the present invention. In another aspect, server 110 can automatically reinitiate the reinforcement learning process of learning program 200 at defined time intervals (e.g., weeks, months, years, etc.), depending on the corresponding business or enterprise associated with data generator 112.

In various embodiments of the present invention, learning program 200 operates by starting with a randomized set of parameters (e.g., P₁) and then calculates a discrepancy score (e.g., D₁) based on the similarity of data generated (e.g., S1) from the randomized set of parameters relative to target data (e.g., target data set 120). Learning program 200 then operates to modify the parameters, or a random subset of the parameters, utilizing a small delta factor. In example aspects, the delta factor is a hyperparameter, similar to the learning step in gradient descent, which is small (e.g., 1/1000 of the parameter value). Accordingly, learning program 200 can determine an updated parameter set based on the delta factor, utilizing a function such as “Pₙ₊₁(=Pₙ(1+Δ))” for selected parameters and calculate a new discrepancy score (e.g., D₂).

Through execution of learning program 200, embodiments of the present invention operate to decrease the respective discrepancy score for each iteration. Accordingly, by decreasing the discrepancy, learning program 200 can reward the modification by the function “R=(Sₙ−Sₙ₊₁)*Δ*α, where α is the learning step and also a hyperparameter. For example, learning program 200 can default the value of α to 0.05, 0.01, etc. Then, learning program 200 can operate to update the parameters P₁=P₀+R to het the new parameter set. In various aspects, updates apply to selected parameters, similar to dropout techniques in deep neural network (DNN). In further aspects, learning program 200 iterates repeatedly until the discrepancy score is below the preset threshold.

FIG. 3 depicts computer system 300, which is representative of server 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made. Computer system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to server 110, software and data 310 includes data generator 112, data discrepancy detector 114, simulated data sets 116, parameter sets 118, and learning program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
generating, by one or more processors, a first simulated data set based on a first parameter set;
generating, by one or more processors, a second parameter set, by modifying one or more parameters of the first parameter set;
generating, by one or more processors, a second simulated data set based on the second parameter set;
determining, by one or more processors, data discrepancies between the first simulated data set and a target data set;
determining, by one or more processors, data discrepancies between the second simulated data set and the target data set;
selecting, by one or more processors, between the first simulated data set and the second simulated data set, a first data set that corresponds to less data discrepancy relative to the target data set; and
comparing, by one or more processors, data discrepancies of the selected first data set to a data discrepancy threshold.

2. The method of claim 1, further comprising:
in response to determining that the selected first data set does not meet the data discrepancy threshold, generating, by one or more processors, a third parameter set, by modifying one or more parameters of the parameter set that corresponds to the first selected data set.

3. The method of claim 2, further comprising:
generating, by one or more processors, a third simulated data set based on the third parameter set;
determining, by one or more processors, data discrepancies between the third simulated data set and the target data set;
selecting, by one or more processors, between the selected first data set and the third simulated data set, a second data set that corresponds to less data discrepancy relative to the target data set; and
comparing, by one or more processors, data discrepancies of the selected second data set to a data discrepancy threshold.

4. The method of claim 1, further comprising:
in response to determining that the selected first data set does meet the data discrepancy threshold, storing, by one or more processors, the parameter set that corresponds to the selected first data set.

5. The method of claim 1, wherein generating the second parameter set, by modifying one or more parameters of the first parameter set, further comprises:
identifying, by one or more processors, a randomized subset of one or more parameters of the first parameter set; and
modifying, by one or more processors, parameters of the randomized subset of one or more parameters of the first parameter set by a hyperparameter value.

6. The method of claim 1, wherein determining data discrepancies between the first simulated data set and the target data set further comprises:
determining, by one or more processors, distance between respective data of the first simulated data set and the target data set.

7. The method of claim 1, further comprising:
determining, by one or more processors, a data discrepancy score for the first simulated data set based on the data discrepancies between the first simulated data set and the target data set; and
determining, by one or more processors, a data discrepancy score for the second simulated data set based on the data discrepancies between the second simulated data set and the target data set.

8. A computer program product comprising:
one or more computer readable storage media and program instructions stored on the one or more computer readable storage media, the program instructions comprising:
program instructions to generating a first simulated data set based on a first parameter set;
program instructions to generate a second parameter set, by modifying one or more parameters of the first parameter set;
program instructions to generate a second simulated data set based on the second parameter set;
program instructions to determine data discrepancies between the first simulated data set and a target data set;
program instructions to determine data discrepancies between the second simulated data set and the target data set;
program instructions to select between the first simulated data set and the second simulated data set, a first data set that corresponds to less data discrepancy relative to the target data set; and
program instructions to compare data discrepancies of the selected first data set to a data discrepancy threshold.

9. The computer program product of claim 8, further comprising program instructions, stored on the one or more computer readable storage media, to:
in response to determining that the selected first data set does not meet the data discrepancy threshold, generate a third parameter set, by modifying one or more parameters of the parameter set that corresponds to the first selected data set.

10. The computer program product of claim 9, further comprising program instructions, stored on the one or more computer readable storage media, to:
generate a third simulated data set based on the third parameter set;
determine data discrepancies between the third simulated data set and the target data set;
select between the selected first data set and the third simulated data set, a second data set that corresponds to less data discrepancy relative to the target data set; and
compare data discrepancies of the selected second data set to a data discrepancy threshold.

11. The computer program product of claim 8, further comprising program instructions, stored on the one or more computer readable storage media, to:
in response to determining that the selected first data set does meet the data discrepancy threshold, store the parameter set that corresponds to the selected first data set.

12. The computer program product of claim 8, wherein the program instructions to generate the second parameter set, by modifying one or more parameters of the first parameter set, further comprise program instructions to:
identify a randomized subset of one or more parameters of the first parameter set; and
modify parameters of the randomized subset of one or more parameters of the first parameter set by a hyperparameter value.

13. The computer program product of claim 8, wherein the program instructions to determine data discrepancies between the first simulated data set and the target data set further comprise program instructions to:
determine distance between respective data of the first simulated data set and the target data set.

14. A computer system comprising:
one or more computer processors;
one or more computer readable storage media; and
program instructions stored on the computer readable storage media for execution by at least one of the one or more processors, the program instructions comprising:
program instructions to generating a first simulated data set based on a first parameter set;
program instructions to generate a second parameter set, by modifying one or more parameters of the first parameter set;
program instructions to generate a second simulated data set based on the second parameter set;
program instructions to determine data discrepancies between the first simulated data set and a target data set;
program instructions to determine data discrepancies between the second simulated data set and the target data set;
program instructions to select between the first simulated data set and the second simulated data set, a first data set that corresponds to less data discrepancy relative to the target data set; and
program instructions to compare data discrepancies of the selected first data set to a data discrepancy threshold.

15. The computer system of claim 14, further comprising program instructions, stored on the computer readable storage media for execution by at least one of the one or more processors, to:
in response to determining that the selected first data set does not meet the data discrepancy threshold, generate a third parameter set, by modifying one or more parameters of the parameter set that corresponds to the first selected data set.

16. The computer system of claim 15, further comprising program instructions, stored on the computer readable storage media for execution by at least one of the one or more processors, to:
generate a third simulated data set based on the third parameter set;
determine data discrepancies between the third simulated data set and the target data set;
select between the selected first data set and the third simulated data set, a second data set that corresponds to less data discrepancy relative to the target data set; and
compare data discrepancies of the selected second data set to a data discrepancy threshold.

17. The computer system of claim 14, further comprising program instructions, stored on the computer readable storage media for execution by at least one of the one or more processors, to:
in response to determining that the selected first data set does meet the data discrepancy threshold, store the parameter set that corresponds to the selected first data set.

18. The computer system of claim 14, wherein the program instructions to generate the second parameter set, by modifying one or more parameters of the first parameter set, further comprise program instructions to:
identify a randomized subset of one or more parameters of the first parameter set; and
modify parameters of the randomized subset of one or more parameters of the first parameter set by a hyperparameter value.

19. The computer system of claim 14, wherein the program instructions to determine data discrepancies between the first simulated data set and the target data set further comprise program instructions to:
determine distance between respective data of the first simulated data set and the target data set.

20. The computer system of claim 14, further comprising program instructions, stored on the computer readable storage media for execution by at least one of the one or more processors, to:
determine a data discrepancy score for the first simulated data set based on the data discrepancies between the first simulated data set and the target data set; and
determine a data discrepancy score for the second simulated data set based on the data discrepancies between the second simulated data set and the target data set.
